(19) United States
(12) Patent Application Publication
(10) Pub. No.: US 2009/0059776 A1
(43) Pub. Date: Mar. 5, 2009

(54) PORTABLE HYBRID STORAGE MEDIUM

(75) Inventors: Christopher Busch, Eindhoven (NL); Alexander Marc Van Der Lee, Eindhoven (NL); Dominique Maria Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,243

(22) PCT Filed: Oct. 31, 2005
(86) PCT No.: PCT/IB05/53544

§ 371 Date: Apr. 30, 2007

(30) Foreign Application Priority Data
Nov. 3, 2004 (EP) 04105504.7

(51) Int. Cl. G11B 7/00

(52) U.S. Cl. 369/275.1; G9B/7

(57) ABSTRACT

The present invention relates to providing a portable storage medium (10,20) and a stamping unit (70) for producing such a portable storage medium (10,20), for enabling reading data at a high data rate and writing data. The portable storage medium (10,20) for storing data, is further insertable in a data reading and/or writing device, comprises a data portion (12,22), wherein the data portion (12,22) comprises a first division comprising a group (32,418,54,64) of essentially parallel transversely separated first tracks (36,39,408), wherein said first tracks (36,39,408) have a first format, and a second division comprising a second track (33,52,62) of a second format, wherein the group (32,418,54,64) of essentially parallel transversely separated first tracks (36,39,408) has a parallel format, so as to enable parallel reading of content at a high data rate.

### FIELD OF THE INVENTION

The present invention relates to providing a portable storage medium and a stamping unit for producing such a portable storage medium, for enabling reading data at a high data rate and writing data.

### BACKGROUND OF THE INVENTION

It is desirable to provide reading from a data medium at a high data rate. In the case of spinning discs, the data access rate has been increased by increasing the spinning speed of the disc for given type of disc and maintained data format. However, the spinning speed may not be increased to very high spinning speeds, since the physical stress of the disc increases with increasing spinning speed and risks damaging the disc and the disc driver.

For gaming applications there is a demand for high data reading rates. As the data reading rates have been higher for reading from a hard disk as compared to for instance an optical disc, gaming software are often buffered on the hard disk, from which data can be accessed at a high data rate. As far as gaming applications go, the user or player often produces individual scores that he or she would like to store, such as high scores, and often has certain parameter settings and equipment tailored for a certain game or game session. As there is a wish to keep and maintain these high scores, parameter settings, etc. some kind of writable unit, such as universal serial bus (USB) memory, for example a memory stick, can be used.

The US patent document U.S. Pat. No. 6,606,294 D2 discloses an optical disk having read only and writable areas. In the read only area a plurality of read only tracks are formed, where each one of the plurality of read only tracks is divided into a plurality of first sectors, where a signal is prerecorded in at least one of the plurality of sectors in a predetermined reproduction format. Similarly, in the writable area a plurality of writable tracks are formed, where each one of the plurality of the writable tracks is divided into a plurality of second sectors, where a signal is recordable in at least one of the plurality of sectors in a predetermined recording format including the predetermined reproduction format. Address information is added to each sector so that the position of required information data can be managed to facilitate high-speed data retrieval, that is a header region which includes an ID signal representing the address information of the sector is provided at the head of the sector. The read only part is located on an inner portion of the optical disk whereas the rewritable area is located on an outer portion of the optical disk. Reading data from the read only portion is made using a first disk driving method and writing to the writable area is made using a second disk driving method.

This patent document describes a data management format in which data may be read from and data may be stored to in order to facilitate data retrieval at an increased speed, by managing the addressing format of the information stored. This may result in that the time required to jump from one data position to the next data position is reduced. There is however no relation to continuous high speed data retrieval.

There is thus still a need for obtaining a high data rate speed read-out capability of content at a low physical scanning speed combined with a writing functionality.

### SUMMARY OF THE INVENTION

It is an object of the present invention to provide enabling reading data at a high data rate from a portable storage medium and rewriting data to the same portable storage medium.

According to a first aspect of the present invention, this object is achieved by a portable storage medium for storing data, insertable in a data reading and/or writing device, comprising a data portion, wherein the data portion comprises a first division comprising a group of essentially parallel transversely separated first tracks, wherein said first tracks have a first format, and a second division comprising a second track of a second format, wherein the group of essentially parallel transversely separated first tracks has a parallel format, so as to enable parallel reading out at a high data rate from the first division.

According to a second aspect of the present invention, this object is achieved by a stamping unit having a stamping region, wherein the stamping region comprises a first division comprising a group of essentially parallel transversely separated first tracks, wherein said first tracks have a first format, and a second division comprising a second track of a second format, wherein the group of essentially parallel transversely separated first tracks has a parallel format, for producing the portable storage medium according to the first aspect of the present invention.

The gist of this invention is to provide enabling parallel reading of data content and enabling writing on the same portable storage medium.

The present invention has the following overall advantages:

By providing enabling parallel reading of data at a high data rate from and writing of data to one and the same portable storage medium, this portable storage medium may replace the hard disk drive of, for instance, portable gaming devices.

Direction of the dependent claims and the advantages thereof:

Claim 3 and 4 are directed toward providing recording and rewriting possibility of data in a second format.

These claims carry the advantage that a user of the portable storage medium can easily record or rewrite data on the portable storage medium.

Claim 6 is directed toward a disc.

This claim brings the advantage that there is no requirement for spinning the disc at a high spinning speed. This is further advantageous since the initial access time is low due to that the required to spin-up is short, that is to reach the desired spinning speed value. At the same time, a low spinning speed brings the advantage that the acoustic noise from the spinning disc is low. In addition spinning the disc at a low spinning speed consumes a low power since the power consumption increases with the third power of the frequency at which the disc is spinning.

Claims 7 and 8 are directed toward the layout of the divisions of data portion of the disc.

These claims bring the advantage that discs having this layout are difficult to illegally duplicate since the layout is a dedicated non-standard layout.

These claims may further have the advantage that the two divisions may be read simultaneously by using one single split-beam laser.

Claim 10 is directed toward a stamper unit a having a stamping region, for producing portable storage media, according to any one of claims 1-9.

This claim is advantageous since it provides an essential element for producing portable storage media according to the present invention.

These and other aspects of the invention will be apparent from and elucidated with reference to the embodiments described hereinafter.

### BRIEF DESCRIPTION OF THE DRAWINGS

The present invention will now be described in more detail in relation to the enclosed drawings, in which:

FIG. 1 is a representation of a portable storage medium of the type of an optical disc, according to one embodiment of the present invention,

FIG. 2 is a representation of a portable storage medium of the type of a stripe card, according to one embodiment of the present invention,

FIG. 3 is a vertical top view of a part of a portable storage medium of the type of an optical disc, according to the present invention,

FIG. 4 is a schematic representation of an optical set-up for parallel access to data of a portable storage medium,

FIG. 5 is a vertical top view of a representation of a portable storage medium, according to one embodiment of the present invention,

FIG. 6 is a vertical top view of a representation of a portable storage medium, according to one embodiment of the present invention, and

FIG. 7 is a lateral view of a stamping unit according to one embodiment of the present invention.

### DESCRIPTION OF PREFERRED EMBODIMENTS

The present invention relates to providing a portable storage medium for reading data at a high data rate and writing data.

For a number of applications, such as for instance gaming, access to data at a very high data rate is often a requirement.

Data access at a high data rate can be provided by using a hard disk drive. One example of a device that uses a hard disk drive for providing a high data rate is the Xbox gaming console by Microsoft, which currently uses a hard disk drive as well as an optical disc drive.

If, however, the hard disk drive could be eliminated from the gaming console, the hardware cost would be reduced by more than $50 US dollars, at current exchange rates and prices.

By eliminating the hard disk drive another unit possibly located within the console would have to provide the functionality of the hard disk drive or at least a functionality similar to the one of said hard disk drive. If substituting for example a novel optical disc drive for the hard disk drive, in this case, this novel optical disc drive would have to provide reading data at high data rates.

Also, it would have to be able to provide reading at very high rates at a relatively low noise level. One way of increasing the data access rate for optical disc drives is to increase the spinning speed of the disc. This measure however has the disadvantage of increasing the noise level as the noise level of the optical discs increases with increasing spinning speeds. High spinning speeds are therefore not required in this novel optical disc drive. Also, very high spinning speeds risk damaging the optical disc due to too high stresses in the disc.

In addition, apart from providing data reading at a very high data rate, some read/rewrite (R/RW) functionality for gaming purposes such as for the game status, user preferences, MODs, patches and updates, etc. would be required of the optical disc drive in substitution of the hard disk drive.

In addition, copyright features of an optical disc may be required to prevent data from being illegally copied or altered.

The problem is thus how to realise a novel optical disc having the properties and functionality as described above.

By giving one division of an optical disc the property of enabling reading data at a high data rate and another division of the optical disc the property of enabling reading and rewriting data, an optical disc having the functionality and properties as described above is achieved.

Further, if more than one track of an optical disc could be read simultaneously, a higher data rate would be achieved as compared to when reading a single track serially.

Now, by implementing a group of essentially parallel separated first tracks in a first division and a second track in a second division, where the first tracks enable reading data simultaneously, and the second track enables reading and rewriting of data, reading data at a high data rate is achieved. Reading the data in the a group of essentially parallel separated tracks is performed by using a multiple of laser beams, one for each track within the group of tracks and letting a multiple photodetector detect a reflected signal from each track.

By implementing a parallel reading of the essentially parallel separated first tracks a high access rate is obtained. This parallel data access is also achieved at a moderate spinning speed of the disc since there is no requirement of spinning the optical disc with a high spinning speed.

For the read/rewrite functionality in the second division, the second track would still read/written by using a serial data access.

Whereas the capability of high-speed writing to optical discs is also an important subject, the requirements for the reading functionality and the recording functionality are not the same in the case of the gaming applications, and or instance applications using home entertainment centers when data quickly is dubbed from an optical disc to a HDD, and where personalisation of the content, for example, specifying favorite scenes, including commercial skips, and so on, is of value.

While there are high requirements on the reading capacity for gaming applications, that is that data has to be accessed at a high data rate and at a low noise, the requirements on the writing capacity is much lower, which means that writing at a high data rate is not a requirement, rather a relatively low data rate, as compared to the data rate at which data can be read, is sufficient.

Since the requirements for reading data from a portable storage medium and writing data to a portable storage medium are different, the format being used for reading at a high data rate and the format being used for read/rewriting data, can be different.

In fact, using different formats opens up a possibility to optimise each format for each functionality. According to one embodiment of the present invention the format in the first division, that is the format for reading data at a high data rate, is a read-only-memory (ROM) format.

Moreover, the absence of a recording possibility for the ROM format acts in this context as an extra copy protection for the optical disc.

By using two different data formats on one single optical disc, a hybrid format disc is obtained. By using the two different formats a dual functionality of the optical disc, enabling reading data at a high date rate and reading/writing data to the optical disc, a hybrid functionality optical disc is obtained. In total, a hybrid² optical disc is thus obtained.

Using such a hybrid² optical disc for gaming platforms would offer a possibility to eliminate the hard disk from the gaming console, thereby reducing the hardware cost significantly. In addition, the above-mentioned features would also be added to a system containing such an optical disc. It should also be noted that these hybrid² optical disks are removable from the console, exchangeable and also portable, providing the described functionality within a singular disc element, without the need of keeping additional memories containing user specific data, in order.

For gaming applications, introducing a new format is not a problem due to the dedicated platform being used in connection with the removable disc. It is even advantageous for copy-protection purposes, since a parallel access ROM format is a non-standard format, which therefore becomes more difficult to master for anyone aiming for producing duplications of such hybrid discs. It is also impossible to copy the hybrid discs by using an ordinary consumer type hardware optical disc drive, affording the hybrid data format an extra degree of security for the content provider.

In order to provide a high data rate reading out functionality and a write functionality, a dual property hybrid format is thus introduced into the portable storage medium according to the present invention.

The hybrid format is manifested in that the ROM-functionality has associated a first track configuration having a first track arrangement and that the R/RW-functionality has associated a second track configuration having a second track arrangement. In this hybrid format the first track arrangement is different from the second track arrangement.

The first track arrangement, provided to enable data reading at high data rates is a so called meta track arrangement. This meta track arrangement is a not a track in the usual sense of a track, but rather a group of tracks grouped together into one meta track arrangement. According to the present invention typically between 5 and 20 individual sub tracks may be grouped together in one single meta track arrangement. In an alternative embodiment a different number of sub tracks may be grouped, forming a meta track arrangement.

With reference to the enclosed figures the present invention is now described in more detail.

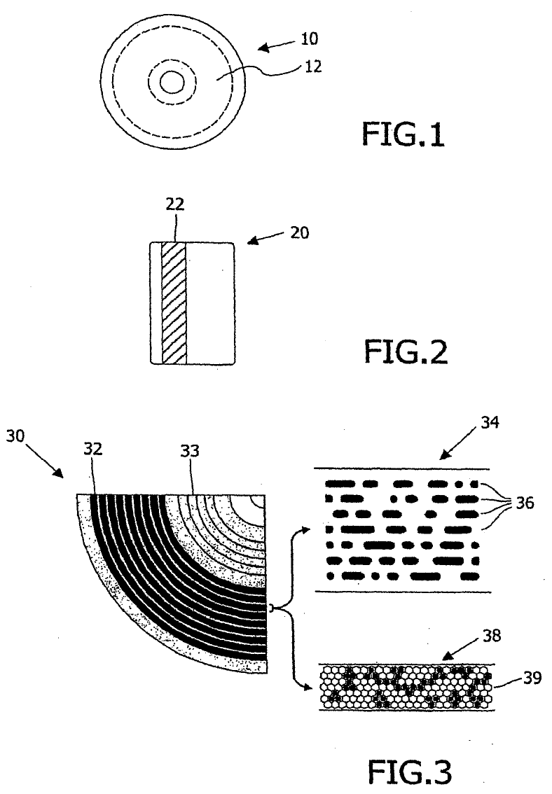

In FIG. 1, a portable storage medium 10 of the type of a disc, according to one embodiment of the present invention, is presented. However, the portable storage medium may be any kind of portable storage medium. One prerequisite is that a reading/writing head of a drive corresponding to the portable storage medium experiences a scanning motion relative to the portable storage medium, when reading data from or writing data to the portable storage medium is performed. For instance, according to another embodiment of the present invention the portable storage medium is a stripe card 20 wherein the stripe 22 comprises the data portion that may contain data information. Upon reading from and/or writing to such a stripe card, the card is typically slided through a card slot of a card reader/drive in which the reading/writing head is located, obtaining the scanning relative. motion between the reading/writing head and the portable storage medium required according to the present invention.

In one alternative embodiment of the present invention, a sledge is moved in a plane parallel to the plane of the stripe card, thus longitudinally (along the longitudinal axis of the stripe) and transversally (along the short axis of the stripe), in 2-dimensional motion.

This sledge, this being an xy sledge (where xy being the two dimensions) would typically contain an optical head for reading from/writing to the stripe.

Within this patent application vertically refers to a direction that is perpendicular to the gross planar surface of a disc or a card or another type of portable storage medium. That is the direction normal to the plane. Longitudinal is the direction along the long side of an elongated medium. Transversal is the direction that is within the gross plane, and which is perpendicular to the longitudinal direction. A radial direction refers to the direction along an increasing radius of a circular object, for instance a planar disc.

In one example of the present invention the portable storage medium is an optical disc, as presented in FIG. 1. A more detailed view of one part of the portable storage medium in the form of the optical disc is presented in FIG. 3, showing a part 30 of the optical disc. Within this part one meta track 32 has been zoomed onto. This figure also shows two different embodiments of the meta track 32, in the form of two different enlarged meta tracks, 34 and 38, according to two different embodiments of the present invention. The upper meta track 34 is, a 1-dimensional (1D) implementation in which the meta track is comprised of a multiple of parallel 1D sub tracks 36. The information in these sub tracks may be uncorrelated, having uncorrelated 1D sub tracks. However, it is advantageous to introduce a correlation between information in neighbouring tracks, that is to have correlated 1D sub tracks. A correlation provides an increased stability in respect of the performance of reading data from and writing data to such sub tracks, and may also be used for tracking purposes. Applying, for instance, a common timing base for all sub tracks, allows joint timing recovery. A shared error correcting code (ECC) between sub tracks enables a better protection against. scratches in the track direction. By these and other options for correlated sub tracks, extra performance stability is gained.

In the case of correlated 1D sub tracks the pitch between the neighbouring 1D sub tracks may be too low, for the sub tracks to be individually used for tracking. In this case tracking may be performed by using for example the outermost sub tracks only.

In FIG. 3, in a second division of the disc 30, a single track 33 having a recordable/rewritable (R/RW) format, is also shown. As this single track encircles the disc it appears as a number of transversally (here radially) separated parallel tracks.

Pregrooves are also provided for the single track in the recordable format as well as for the rewritable format to enable tracking during recording and rewriting of data.

The implementation of having 1D tracks forming the meta track, combined with a recordable/rewritable track, has the advantage that it is relatively simple, can be produced at a low cost and shows a stable performance.

The lower meta track 38 is a 2D implementation and comprises tightly packed sub tracks 39 that are located very close together such that cross-talk between the sub tracks is significant, together forming a true 2-D implementation. The requirements for writing to this kind of meta track 38 is much higher than for the meta track 34 as depicted above, and in respect of certain formats even present research challenges.

There are thus many advantages of providing a ROM format in the first division by using a meta track arrangement and a R/RW format in the second division by using a single track arrangement.

A hybrid portable storage medium having such a hybrid asymmetric ROM-R/RW format system has significant implementation advantages and at the same time possesses a significant application relevance.

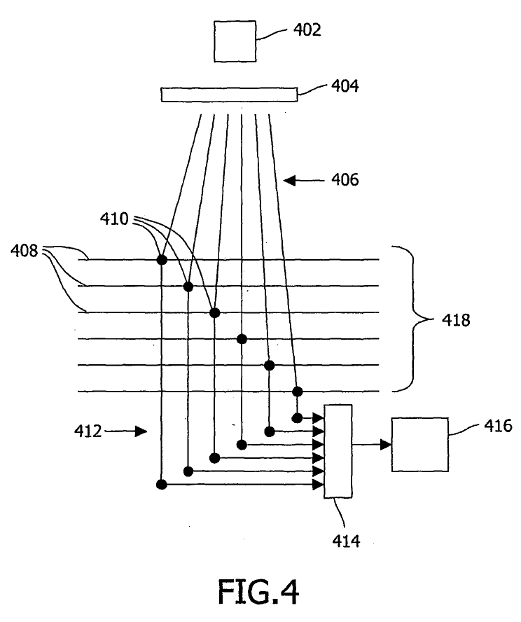

The meta track arrangements as shown in FIG. 3, in the 1D-implementation 34 and in the 2D-implementation 38, are parallel data formats. This means that they are read in a parallel manner. This manner will now be described in more detail with reference to FIG. 4.

In FIG. 4 a schematic representation of an optical set-up for parallel reading of data of a ROM division of a portable storage medium is shown. The set-up comprises a laser 402, a diffraction grating 404, a multi-channel photo detector 414 and a signal processing unit 416. The principle behind the function of this set-up is that a laser beam from the laser 402 is split into multiple laser sub beams 406, by the diffraction grating 404, where each of which sub beams 406 reads one sub-track 408. From the reading point 410 in each sub track 408, light from each sub beam 406 is reflected 412 and directed in to the multi-channel photo detector 414, from which signals representing the read content are lead to the signal processing unit 416.

As this data format is parallel all these sub tracks 408 are read simultaneously upon reading of the meta track 418. By reading the sub tracks at the same time, a higher data rate is obtained as compared to the case in which a single track having a single track arrangement is read. Digital signal processing of the signals as obtained from the multi-channel photo-detector is subsequently required to construe the content being stored in the meta track.

Needless to say, digital signal processing of the content to be stored may be required prior to storing the data in a meta track format.

The first division of a portable storage medium comprising a group of first tracks 418, or a meta track as discussed so far comprises the meta track 418 and the sub tracks 408 comprising the read-only format of the portable storage medium. The rewritable division of the medium however is also required.

According to one embodiment of the present invention, the first division and the second division of the portable storage medium may be physically separated in different regions of the disc. One region may be defined as an inner region of the disc, defined by the radius being smaller than a certain value, comprising one division of the portable storage medium according to on embodiment of the present invention. Another region of the disc, defined by the radius being larger than a certain value, is according to the same embodiment another division of the portable storage medium.

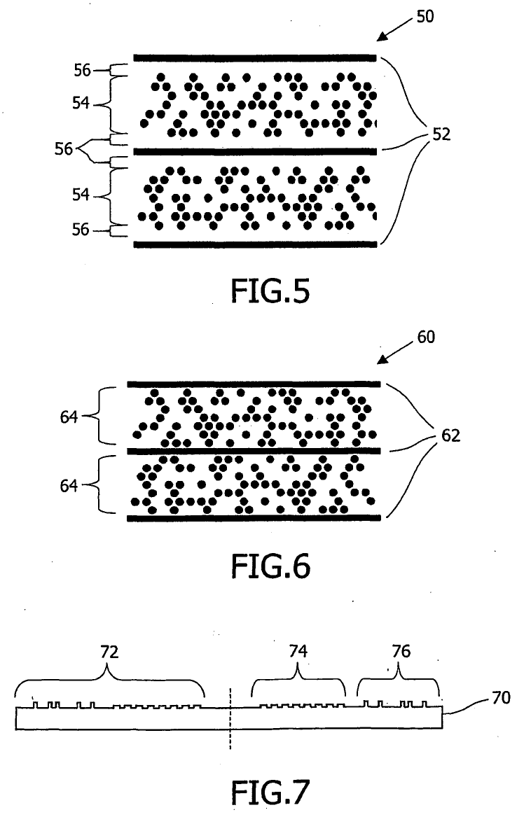

According to another embodiment of the present invention, the two divisions both physically encircle the optical disc and are interleaved in relation to one another. One example of such an embodiment is shown in FIG. 5, showing a vertical view of a representation of a portable storage medium according to one embodiment of the present invention. The figure shows the first division and the second divisions, wherein the first division contains the meta track 54 and wherein the second division comprises the R/RW track 52. It can be seen that the meta track 54 is flanked by the R/RW track 52.

In order to clarify the representation of the portable storage medium of FIG. 5, the two meta track pieces 54 shown in FIG. 5 are pieces from neighbouring turns of the same meta track that encircles the optical disc. Likewise the R/RW-single track that may look like separate pieces 52 in FIG. 5 are representations from neighbouring tracks from one and the same singular R/RW track 52 that is encircling the disc, being interleaved with the meta track 54.

FIG. 5 also shows two guard bands 56. These guard bands provide mirror areas that are used for tracking of the meta track. Grouping sub tracks together into a meta track arrangement thus provides the advantage that tracking may be performed by tracking the guard bands provided in between the meta track and the R/RW-track. There is thus no need to track the individual sub tracks since the position of each sub track with the meta track is defined and the tracking of the meta track is determined by the use of the guard bands 56.

Tracking of the meta track arrangement and the R/RW-track arrangement is performed upon reading either one of the formats at a time or when reading both formats simultaneously.

According to one embodiment of the present invention, both track arrangements may be read simultaneously, despite the fact that the meta track is a parallel format and the R/RW track is a serial format, by using a laser beam that is split into a number sub beams such that the number covers the number of sub tracks comprised in the meta track and the R/RW-track itself.

By providing a guard band in between the ROM division and the R/RW-division no extra pre-cautions against cross-talk between data stored in the two divisions have to be taken.

FIG. 6 shows another vertical view of a representation of a portable storage medium according to one embodiment of the present invention. This embodiment shows the meta track 64 wherein the single R/RW-track 62 is closely flanking the meta track 64. In this embodiment however, there is no standard guard band 56, as presented in FIG. 5. In order for this track embodiment to properly work, certain requirements have to be fulfilled.

In order to avoid data cross-talk between the meta track arrangement and the single R/RW-track arrangement it is advantageous to separate the two track arrangements in the spatial frequency domain. By performing such a separation the multi-channel photodetector detects one frequencies for the meta track arrangement that are different from the signal frequency of the single R/RW-track. This facilitates the separation of the signals from the different track arrangements and decreases the cross-talk between the two.

Also, to enable tracking, a different reflectivity of first division for the ROM format and the second division for the R/RW format can for example be exploited. By using different reflectivities, different direct current levels will be detected. By for instance using a reflectivity for the ROM meta track of approximately 50% of that of the mirror level, and a reflectivity for the R/RW single track much lower, different direct current levels will be obtained and tracking will be facilitated.

In fact, the low reflectivity of most RW tracks arrangements actually almost automatically provide different direct current levels. Of course different direct current levels may be used and in principle also higher levels for the RW track than for the ROM track.

In one embodiment of the present invention the standard 2D tracking servo can operate with the condition that the direct current level of the R/RW track, that is the outer spots 410 in FIG. 4, is lower than a certain threshold before a servo loop can be closed and tracking is performed. Alternatively, the direct current level of the R/RW-track may be higher than a certain threshold before said servo loop is closed and tracking is performed.

FIG. 7 is a lateral schematic representation of stamping unit 70 according to the present invention, for producing for instance an optical disc. This figure shows two portions separated vertically from each other. However the number of portions may different then two. Also, the relative thicknesses of, the two portions are in no respect to scale in this schematic representation.

An illustration of a stamping unit 70 according to one embodiment of the present invention is shown in FIG. 7, wherein the stamping region 72 is divided in two stamping divisions, a first stamping division 74 and a second stamping division 76. The stamping unit according to this embodiment is designed for the production of portable storage media in the form of optical discs in which the first division and the second division are radially (=tranversally) separated in two different sections. The first stamping division 76 may be used for the production of the ROM-tracks and the second stamping division 74 may be used for the production of the single recordable/rewritable track requiring a pregroove.

In a production of optical discs, as one type of a portable storage media, the stamping unit 70 may be used together with, for instance, an injection moulding process to produce an imprint of the stamping region 72 in a polycarbonate layer. The polycarbonate layer, may subsequently be sputtered to produce a mirror region after which a recording layer can be applied by for example spin-coating or sputtering techniques. Subsequently the thus produced sandwich may be bonded to a substrate and subjected to a cover layer.

For the production of portable storage media in the form of discs in which the first division is provided in a first layer and the second division is provided in a second layer, two stamping units may be used, one for producing the imprint of the first division comprising the ROM-format tracks and the other for producing the imprint of the second division comprising the R/RW single track. According to an alternative the entire surface of one layer may be used for the ROM tracks and the entire surface of the second layer for R/RW tracks. The two layers are either built up sequentially on one and the same substrate, or glued together after their individual replication.

The production method is dependent on the type of portable storage medium or disc. As the disc as described in the present invention may be any type of disc, such as a digital versatile disc (DVD), a high definition DVD (HD-DVD) or a Blu-ray disc (BD) the method for producing the disc and the numbers of portions and layers differ. The prerequisite for the production using for instance the injection moulding technique is the stamping unit 70.

The portable storage medium and the method for producing such a portable storage medium according to the present invention have the following advantages:

By providing enabling parallel reading of data at a high data rate from and writing of data to one and the same portable storage medium, this portable storage medium may replace the hard disk drive of, for instance, portable gaming devices.

Another advantage is that an end user of the portable storage medium can easily record or rewrite data on the portable storage medium.

By having the portable storage medium in the form of a disc other advantages are gained, such as that there is no requirement for spinning the disc at a high spinning speed to obtain the high data rate. This is further advantageous since the initial access time is low due to that the required to spin-up is short, that is to reach the desired spinning speed value. At the same time, a low spinning speed brings the advantage that the acoustic noise from the spinning disc is low. In addition spinning the disc at a low spinning speed consumes a low power since the power consumption increases with the third power of the frequency at which the disc is spinning.

Hybrid format discs brings the advantage that they are difficult to illegally duplicate using consumer recording drives since the their format is a dedicated non-standard format.

It shall be paid attention to that:

“Comprising” or “comprises” does not exclude other elements, steps, units, etc.

“A” or “an” does not exclude a plurality of the respective items.

A single processor or other processing unit may fulfill the functions of several units recited in the claims.

The reference signs in the claims shall not be construed as limiting the scope.

It is emphasized that this invention can be varied in many more ways, of which the alternative embodiments below only are examples of a few. These different embodiments are hence non-limiting examples. The scope of the present invention, however, is only limited by the subsequently following claims.

According to another embodiment of the present invention, the implementation of the meta track and the R/RW track may be designed in many different ways. For instance, the single rewritable track may be embedded in the middle of each meta track. Alternatively, the rewritable track may be embedded within the meta track at another relative location.

According to an alternative embodiment the portable storage media in the form a card may have any designs, having various shapes of the data carrying portion. The data carrying portion may have a square shape, a rectangular shape, an elongated shape, a circular shape, as alternatives to the obvious stripe shape. These cards may moreover comprise more than one data carrying portion, for example two, three or even more.

1. A portable storage medium (10,20) for storing data, insertable in a data reading and/or writing device, comprising a data portion (12,22), wherein the data portion (12,22) comprises a first division comprising a group (32,418,54,64) of essentially parallel transversely separated first tracks (36,39,408), wherein said first tracks (36,39,408) have a first format, and a second division comprising a second track (33,52,62) of a second format, wherein the group (32,418,54,64) of essentially parallel transversely separated first tracks (36,39,408) has a parallel format, so as to enable parallel reading out at a high data rate from the first division.

2. The portable storage medium (10,20) according to claim 1, wherein the first format is a read only format and wherein the first tracks (36,39,408) comprise stored content.

3. The portable storage medium (10,20) according to claim 1, wherein the second format is a recordable format and wherein the second track (33,52,62) comprises a pregroove.

4. The portable storage medium (10,20) according to claim 1, wherein the second format is a rewritable format and wherein the second track (33,52,62) comprises a pregroove.

5. The portable storage medium (10,20) according to claim 1, wherein the data portion (12,22) comprises a first layer and a second layer being vertically displaced from one another, wherein the first layer comprises the first division and the second layer comprises the second division.

6. The portable storage medium (10,20) according to claim 1, according to claim 1 wherein the portable storage medium (10,20) is a disc (10).

7. The portable storage medium (10,20) according to claim 6, wherein the first and second divisions physically encircle the disc (10).

8. The portable storage medium (10,20) according to claim 7, wherein the first and second divisions are interleaved.

9. The portable storage medium (10,20) according to claim 1, wherein the portable storage medium (10,20) is an optical memory card (20).

10. Stamping unit (70) comprising a stamping region (72), wherein the stamping region (72) comprises a first stamping division (76) comprising a group (32,418,54,64) of essentially parallel transversely separated first tracks (36,39,408), wherein said first tracks (36,39,408) have a first format, and wherein the group (32,418,54,64) of essentially parallel transversely separated first tracks (36,39,408) has a parallel format, for producing the portable storage medium according to claim 1.

11. Stamping unit (70) according to claim 10, wherein the stamping region (72), further comprises a second stamping division (74) comprising a second track (33,52,62) of a second format.
